(19) United States
(12) Patent Application Publication
(10) Pub. No.: US 2026/0339324 A1
(43) Pub. Date: Oct. 29, 2026

(54) FLIGHT CONTROL SYSTEM AND FLIGHT CONTROL METHOD OF DRONE GROUP

(71) Applicant: QISDA CORPORATION, Taoyuan City (TW)

(72) Inventors: KUO-ZHI FANG, Taoyuan City (TW); CHIH-MING CHANG, Taoyuan City (TW); MING-SHENG YANG, Taoyuan City (TW); HSIANG-JUI LIAO, Taoyuan City (TW)

(21) Appl. No.: 19/363,613

(22) Filed: Oct. 20, 2025

(30) Foreign Application Priority Data
Apr. 28, 2025 (TW) 114115849

(51) Int. Cl. G05D 1/229; G05D 1/24; G05D 109/25

(52) U.S. Cl. CPC G05D 1/2295; G05D 1/24; G05D 2109/254

(57) ABSTRACT

A flight control system and a flight control method of a drone group. The flight control system includes a plurality of positioning devices, a plurality of remote-control devices and a server device. When the positioning device detects a satellite signal and an interference signal, the positioning device generates a satellite signal strength and an interference signal strength. When the positioning device determines that a current strength ratio between the satellite signal strength and the interference signal strength is different from a historical strength ratio, the positioning device calculates a current interference source coordinate according to the interference signal strength and the satellite signal strength, and transmits the current interference source coordinate to the server device through the remote-control device. The server device replaces the historical electronic fence information with updated electronic fence information according to the current interference source coordinate.

### CROSS-REFERENCE TO RELATED PATENT APPLICATION

This application claims the benefit of priority to Taiwan Patent Application No. 114115849, filed on Apr. 28, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a flight control system and a flight control method, and more particularly to a flight control system of a drone group and a flight control method of the drone group.

### BACKGROUND OF THE DISCLOSURE

In recent years, due to the rapid development of drone technology, drones have gradually been used for civilian and government purposes, such as taking photos, transporting, inspecting, and disaster rescue.

If high-voltage towers and high-voltage wires appear during a drone's mission, the electromagnetic waves generated by the towers and high-voltage wires will interfere with the drone's reception and decoding of satellite positioning signals, causing the drone to be unable to obtain correct satellite positioning information and be unable to continue its mission, and even drift off course or start landing while still in the air.

In addition, if an unscrupulous person uses a jammer to transmit a jamming signal to a drone, the jamming signal will interfere with the drone's reception and decoding of satellite positioning signals, causing the drone to be unable to continue its mission.

### SUMMARY OF THE DISCLOSURE

In response to the above-referenced technical inadequacies, the present disclosure provides a flight control system of a drone group and a flight control method of the drone group.

In order to solve the above-mentioned problems, one of the technical aspects adopted by the present disclosure is to provide a flight control system of a drone group. The drone group includes a plurality of drones. The flight control system includes a plurality of positioning devices, a plurality of remote-control devices and a server device. The positioning devices are respectively arranged on the plurality of drones. The remote-control devices are respectively communicated with the plurality of positioning devices. The server device is communicated with the remote-control devices and stores historical electronic fence information. Each of the positioning devices is configured to detect a satellite signal and detect whether there is an interference signal. When the positioning device detects that there is the interference signal, the positioning device is configured to generate a satellite signal strength of the satellite signal and an interference signal strength of the interference signal, and the positioning device is configured to calculate a current strength ratio of the satellite signal strength to the interference signal strength and determine whether the current strength ratio is different from a historical strength ratio. When the current strength ratio is different from the historical strength ratio, the positioning device is configured to calculate a current interference source coordinate according to the interference signal strength and the satellite signal strength, and transmit the current interference source coordinate to the server device through the remote-control device. The server device is configured to replace historical electronic fence information with updated electronic fence information according to the current interference source coordinate and transmit the updated electronic fence information to the plurality of positioning devices through the plurality of remote-control devices.

In order to solve the above-mentioned problems, another one of the technical aspects adopted by the present disclosure is to provide a flight control method of a drone group, the drone group includes a plurality of drones, the drones correspond to a plurality of remote-control devices, respectively. Positioning devices are respectively provided on the plurality of drones and respectively communicated with the plurality of remote-control devices, the flight control method includes: detecting, by each of the positioning devices, a satellite signal; detecting, by each of the positioning devices, whether there is an interference signal; in which, when the positioning device detects that there is the interference signal, the positioning device generates a satellite signal strength of the satellite signal and an interference signal strength of the interference signal; calculating, by each of the positioning devices, a current strength ratio of the satellite signal strength to the interference signal strength; determining, by each of the positioning devices, whether the current strength ratio is different from a historical strength ratio; in which, when the current strength ratio is different from the historical strength ratio, the positioning device calculates a current interference source coordinate according to the interference signal strength and the satellite signal strength and transmits the current interference source coordinate to the remote-control device; transmitting, by the remote-control device, the current interference source coordinate to a server device; replacing, by the server device, historical electronic fence information with updated electronic fence information according to the current interference source coordinate; transmitting, by the server device, the updated electronic fence information to the plurality of remote-control devices; and transmitting, by the plurality of remote-control devices, the updated electronic fence information to the plurality of positioning devices, respectively.

Therefore, in the flight control system and the flight control method of the drone group provided by the present disclosure, when the positioning device provided on any one of the drones determines that the ratio of the satellite signal strength to the interference signal strength is changed, it indicates that a new interference source has appeared. The drone interfered by the new interference source transmits an interference source coordinate to the server device through the remote-control device. The server device updates electronic fence information according to the interference source coordinate and transmits the updated electronic fence information to each of the drones. In this way, one part of the drone group that has not been interfered by the new interference source can move away from the new interference source in advance, and another part of the drone group that has been interfered by the new interference source can immediately move away from the new interference source.

These and other aspects of the present disclosure will become apparent from the following description of the embodiment taken in conjunction with the following drawings and their captions, although variations and modifications therein may be effected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a drone group in a first scenario of the present disclosure;

FIG. 2 is a functional block diagram of a flight control system of the drone group of FIG. 1 according to a first embodiment of the present disclosure;

FIG. 3 is a functional block diagram of a positioning device of FIG. 2;

FIG. 4 is functional block diagram of a remote-control device of FIG. 2;

FIG. 5 is a functional block diagram of a server device of FIG. 2;

FIG. 6 is a schematic view of the drone group in a second scenario of the present disclosure;

FIGS. 7A-7B are flowcharts of a flight control method of the drone group according to the first embodiment of the present disclosure;

FIGS. 8A-8B are flowcharts of the flight control method of the drone group according to a second embodiment of the present disclosure;

FIG. 9 is a flowchart of the flight control method of the drone group according to a third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

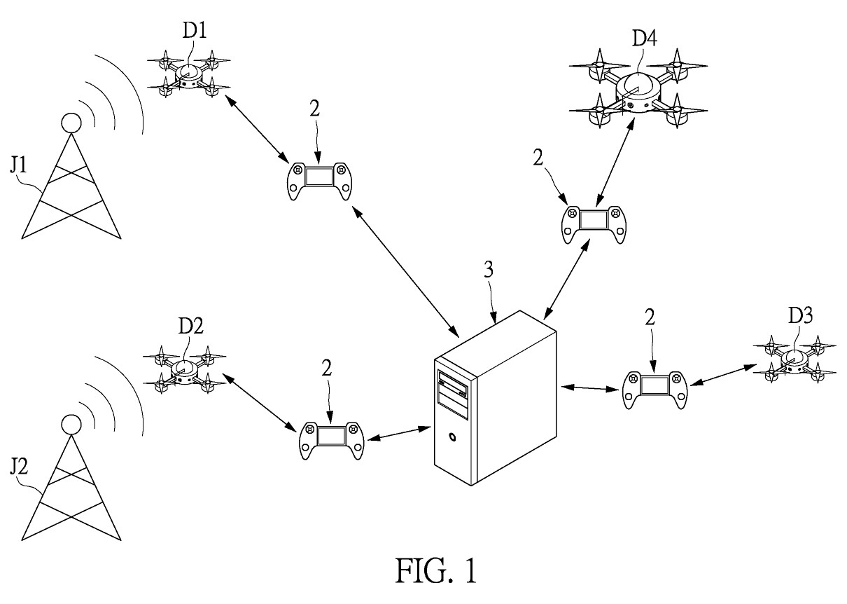

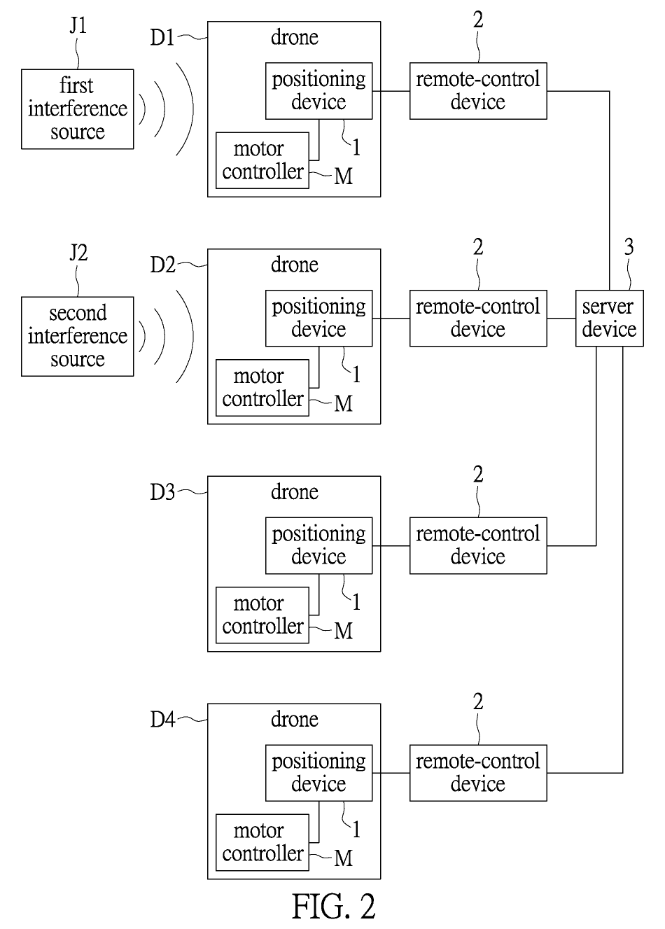

FIG. 1 is a schematic view of a drone group in a first scenario of the present disclosure, and FIG. 2 is a functional block diagram of a flight control system of the drone group of FIG. 1 according to a first embodiment of the present disclosure. Referring to FIGS. 1, and 2, the drone group includes a plurality of drones D1-D4. The flight control system includes a plurality of positioning devices 1, a plurality of remote-control devices 2, and a server device 3. The positioning devices 1 are respectively arranged on the drones D1-D4. Each of the drones D1-D4 is provided with a motor controller M, and the motor controller M is electrically connected to the positioning device 1. The remote-control devices 2 correspond to the drones D1-D4, respectively. The remote-control devices 2 are respectively communicated with the positioning devices 1, respectively. Therefore, each of the remote-control device 2 may transmit signals and information to the positioning device 1 and receive signals and information from the positioning device 1. The server device 3 is communicated with the remote-control devices 2. Therefore, the server device 3 may transmit signals and information to each of the remote-control devices 2, and each of the remote-control devices 2 may transmit signals and information to the server device 3. The drone D1 detects an interference signal of a first interference source J1, and the drone D2 detects an interference signal of a second interference source J2. The first interference source J1 and the second interference source J2 are, for example, high-voltage towers, high-voltage wires, or jammers.

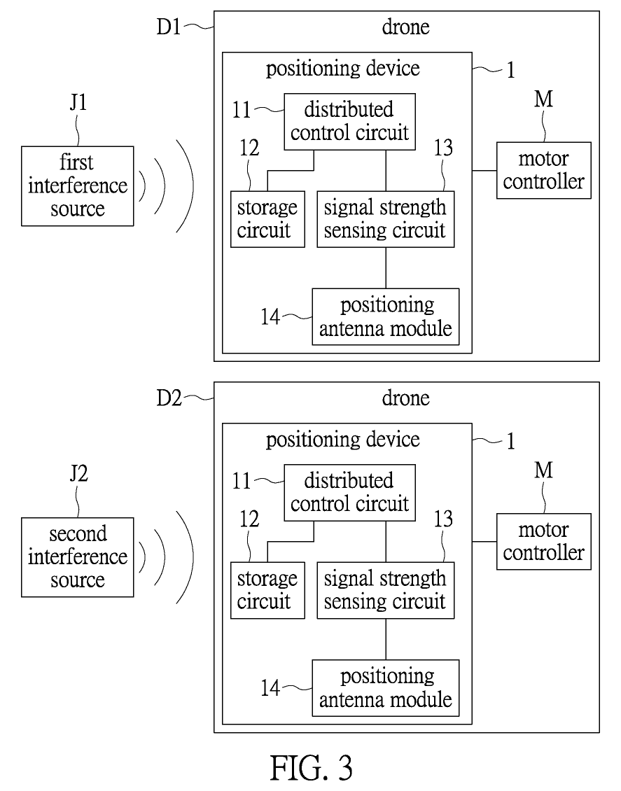

FIG. 3 is a functional block diagram of a positioning device of FIG. 2. Referring to FIG. 3, each of the positioning devices 1 includes a distributed control circuit 11, a storage circuit 12, a signal strength sensing circuit 13, and a positioning antenna module 14. The distributed control circuit 11 is, for example, a programmable logic controller circuit, a micro-processor circuit, a micro-control circuit, or other processor or controller with a signal processing function. The storage circuit 12 is, for example, a random-access memory (RAM), a read only memory (ROM), a flash memory, a hard disk, or other storage device with data storage function. The distributed control circuit 11 is electrically connected to the storage circuit 12, the signal strength sensing circuit 13, and the positioning antenna module 14. The positioning antenna module 14 is electrically connected to the signal strength sensing circuit 13.

The positioning antenna module 14 includes, for example, a radio frequency circuit, a baseband circuit, a media access control circuit and a plurality of antennas. The media access control circuit is connected to the baseband circuit, the baseband circuit is connected to the radio frequency circuit, and the radio frequency circuit is connected to the plurality of antennas.

The positioning antenna module 14 of the drone D1 detects a first satellite signal and a first interference signal of the first interference source J1, and the signal strength sensing circuit 13 of the drone D1 generates a satellite signal strength of the first satellite signal and an interference signal strength of the first interference signal.

The distributed control circuit 11 of the drone D1 calculates a current strength ratio between the satellite signal strength of the first satellite signal and the interference signal strength of the first interference signal, and determines whether the current strength ratio is different from a historical strength ratio stored in the storage circuit 12. The historical strength ratio is a ratio between the satellite signal strength and the interference signal strength calculated previously by the distributed control circuit 11 of the drone D1. In detail, since a coordinate of a new interference source is different from that of an old interference source, a strength of an interference signal emitted by the new interference source is different from that emitted by the old interference source, resulting in a change in the ratio of the satellite signal strength to the interference signal strength. In this way, by monitoring whether the ratio of the satellite signal strength to the interference signal strength is changed, it is determined whether the interference signal comes from the new interference source.

When the distributed control circuit 11 of the drone D1 determines that the current strength ratio is different from the historical strength ratio, the distributed control circuit 11 of the drone D1 determines that the first interference source J1 is a new interference source and replaces the historical strength ratio stored in the storage circuit 12 of the drone D1 with the current strength ratio. The distributed control circuit 11 of the drone D1 calculates the drone coordinate of the drone D1 according to the first satellite signal, and the distributed control circuit 11 of the drone D1 determines a relative distance between the drone D1 and the first interference source J1 according to the interference signal strength of the first interference signal. When the positioning antenna module 14 of the drone D1 receives the first interference signal, a relative orientation between the drone D1 and the first interference source J1 can be obtained by the positioning antenna module 14 of the drone D1. The distributed control circuit 11 of the drone D1 calculates a current interference source coordinate of the first interference source J1 according to the relative distance, relative orientation and the drone coordinate of the drone D1.

The positioning antenna module 14 of the drone D2 detects a second satellite signal and a second interference signal of the second interference source J2, and the signal strength sensing circuit 13 of the drone D2 generates a satellite signal strength of the second satellite signal and an interference signal strength of the second interference signal.

The distributed control circuit 11 of the drone D2 calculates a current strength ratio between the satellite signal strength of the second satellite signal and the interference signal strength of the second interference signal, and determines whether the current strength ratio is different from a historical strength ratio stored in the storage circuit 12 of the drone D2. The historical strength ratio is a ratio between the satellite signal strength and the interference signal strength calculated previously by the distributed control circuit 11 of the drone D2.

When the distributed control circuit 11 of the drone D2 determines that the current strength ratio is different from the historical strength ratio, the distributed control circuit 11 of the drone D2 determines that the second interference source J2 is a new interference source and replaces the historical strength ratio stored in the storage circuit 12 of the drone D2 with the current strength ratio. The distributed control circuit 11 of the drone D2 calculates a drone coordinate of the drone D2 according to the second satellite signal, and the distributed control circuit 11 determines a relative distance between the drone D2 and the second interference source J2 according to the interference signal strength of the second interference signal. When the positioning antenna module 14 of the drone D2 receives the second interference signal, a relative orientation between the drone D2 and the second interference source J2 can be obtained by the positioning antenna module 14 of the drone D2. The distributed control circuit 11 of the drone D2 calculates a current interference source coordinate of the second interference source J2 according to the relative distance, the relative orientation and the drone coordinate of the drone D2.

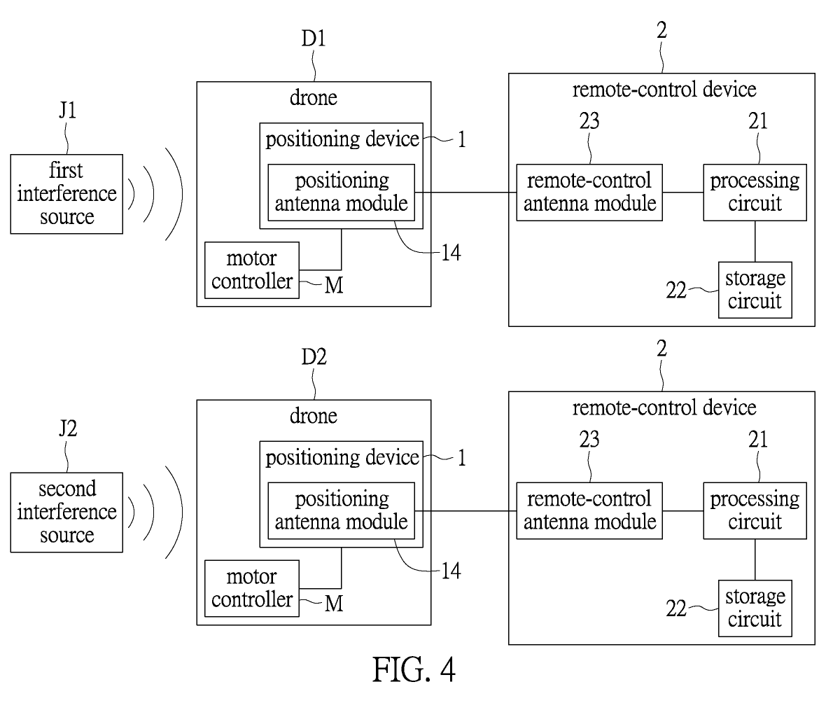

FIG. 4 is functional block diagram of a remote-control device of FIG. 2. Referring to FIG. 4, each of the remote-control devices 2 includes a processing circuit 21, a storage circuit 22 and a remote-control antenna module 23, and the processing circuit 21 is electrically connected to the storage circuit 22 and the remote-control antenna module 23.

The processing circuit 21 is, for example, a programmable logic controller circuit, a micro-processor circuit, a micro-control circuit, or other processor or controller with a signal processing function.

The storage circuit 22 is, for example, a random-access memory (RAM), a read only memory (ROM), a flash memory, a hard disk, or other storage device having a data storage function.

The remote-control antenna module 23 includes, for example, a radio frequency circuit, a baseband circuit, a media access control circuit and an antenna. The media access control circuit is connected to the baseband circuit, the baseband circuit is connected to the radio frequency circuit, and the radio frequency circuit is connected to the antenna.

The positioning antenna module 14 of the drone D1 transmits the current interference source coordinate of the first interference source J1 to the remote-control device 2 corresponding to the drone D1, and the remote-control antenna module 23 of the remote-control device 2 receives the current interference source coordinate of the first interference source J1 and transmits the current interference source coordinate of the first interference source J1 to the processing circuit 21. The processing circuit 21 of the remote-control device 2 reads the current interference source coordinate of the first interference source J1 and stores the current interference source coordinate of the first interference source J1 in the storage circuit 22 of the remote-control device 2. The processing circuit 21 of the remote-control device 2 transmits the current interference source coordinate of the first interference source J1 to the server device 3 through the remote-control antenna module 23.

The positioning antenna module 14 of the drone D2 transmits the current interference source coordinate of the second interference source J2 to the remote-control device 2 corresponding to the drone D2, and the remote-control antenna module 23 of the remote-control device 2 receives the current interference source coordinate of the second interference source J2 and transmits the current interference source coordinate of the second interference source J2 to the processing circuit 21 of the remote-control device 2. The processing circuit 21 of the remote-control device 2 reads the current interference source coordinate of the second interference source J2 and stores the current interference source coordinate of the second interference source J2 in the storage circuit 22 of the remote-control device 2. The processing circuit 21 of the remote-control device 2 transmits the current interference source coordinate of the second interference source J2 to the server device 3 through the remote-control antenna module 23.

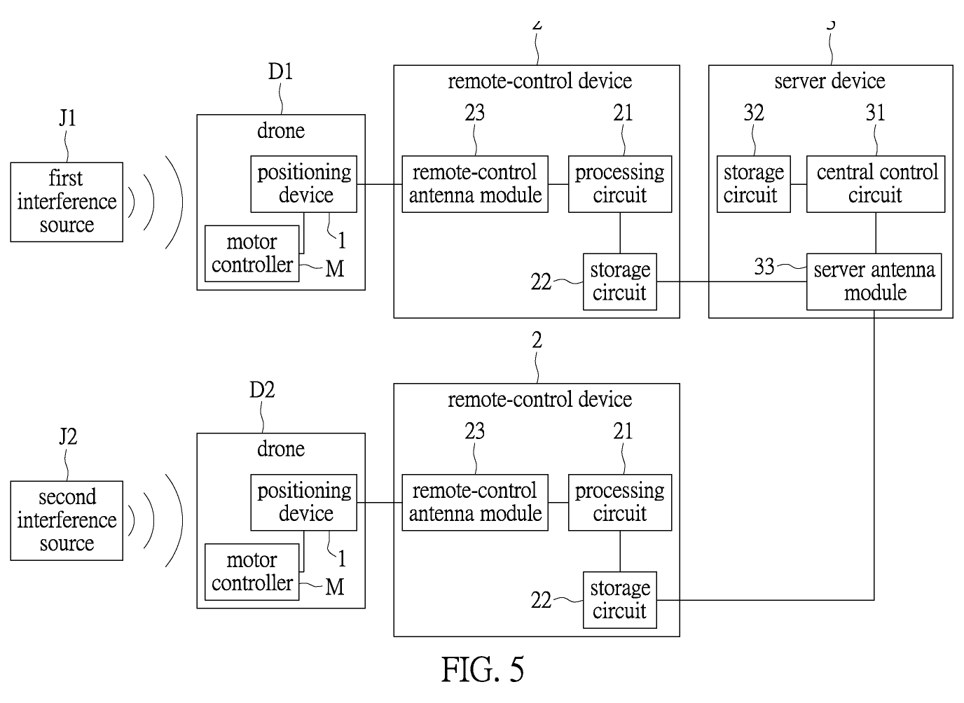

FIG. 5 is functional block diagram of a server device of FIG. 2, the server device 3 includes a central control circuit 31, a storage circuit 32 and a server antenna module 33. The central control circuit 31 is electrically connected to the storage circuit 32 and the server antenna module 33. The storage circuit 32 stores historical electronic fence information.

The central control circuit 31 is, for example, a programmable logic controller circuit, a micro-processor circuit, a micro-control circuit, or other processor or controller with a signal processing function.

The storage circuit 32 is, for example, a random-access memory (RAM), a read only memory (ROM), a flash memory, a hard disk, or other storage device having a data storage function.

The server antenna module 33 includes, for example, a radio frequency circuit, a baseband circuit, a media access control circuit and a plurality of antennas. The media access control circuit is connected to the baseband circuit, the baseband circuit is connected to the radio frequency circuit, and the radio frequency circuit is connected to the plurality of antennas.

The server antenna module 33 receives the current interference source coordinate of the first interference source J1 and the current interference source coordinate of the second interference source J2, and transmits the current interference source coordinate of the first interference source J1 and the current interference source coordinate of the second interference source J2 to the central control circuit 31. The central control circuit 31 reads the current interference source coordinate of the first interference source J1 and the current interference source coordinate of the second interference source J2 and calculates updated electronic fence information according to the current interference source coordinate of the first interference source J1 and the current interference source coordinate of the second interference source J2. The central control circuit 31 replaces the historical electronic fence information stored in the storage circuit 32 with the updated electronic fence information. The central control circuit 31 transmits the updated electronic fence information to the plurality of remote-control devices 2 through the server antenna module 33, and the plurality of remote-control devices 2 transmit the updated electronic fence information to the plurality of positioning devices 1, respectively.

The updated electronic fence information includes an interference range, and the interference range is defined by an upper limit of a longitude coordinate, a lower limit of a longitude coordinate, an upper limit of a latitude coordinate, a lower limit of a latitude coordinate, an upper limit of an altitude, and a lower limit of an altitude. When the positioning device 1 of the drone D1 receives the updated electronic fence information, a motor controller of the drone D1 controls the drone D1 to leave the interference range. When the positioning device 1 of the drone D2 receives the updated electronic fence information, a motor controller of the drone D2 controls the drone D2 to leave the interference range. When the positioning device 1 of the drone D3 receives the updated electronic fence information, a motor controller of the drone D3 controls the drone D3 to move in advance in a direction away from the interference range. When the positioning device 1 of the drone D4 receives the updated electronic fence information, a motor controller of the drone D4 controls the drone D4 to move in advance in a direction away from the interference range.

In this way, multiple drones that have been interfered by the interference source can move away from the interference source according to the updated electronic fence information, and other drones that have not been interfered by the interference source can move in advance in the direction away from the interference source according to the updated electronic fence information.

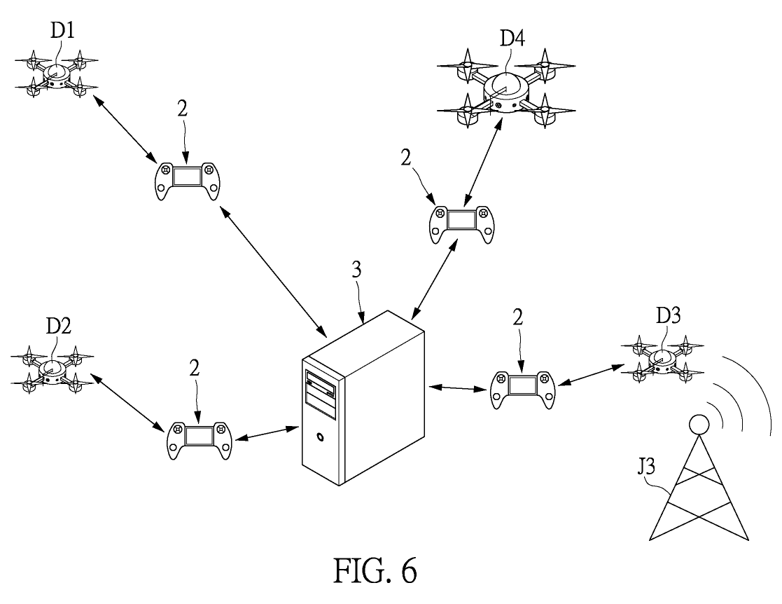

FIG. 6 is a schematic view of the drone group in a second scenario of the present disclosure. Differences between FIGS. 6, 1 are described below. The drone D3 is interfered by a third interference source J3, the positioning antenna module 14 of the drone D3 receives a satellite signal and an interference signal of the third interference source J3, and the signal strength sensing circuit 13 of the drone D3 generates a satellite signal strength of the satellite signal and an interference signal strength of the interference signal. The distributed control circuit 11 of the drone D3 calculates a current strength ratio between the satellite signal strength and the interference signal strength of the third interference source J3, and determines whether the current strength ratio is different from a historical strength ratio stored in the storage circuit 12 of the drone D3. The historical strength ratio is a ratio between the satellite signal strength and the interference signal strength calculated previously by the distributed control circuit 11 of the drone D3.

When the distributed control circuit 11 of the drone D3 determines that the current strength ratio is different from the historical strength ratio, the distributed control circuit 11 of the drone D3 confirms that the third interference source J3 is a new interference source and replaces the historical strength ratio stored in the storage circuit 12 of the drone D3 with the current strength ratio. The distributed control circuit 11 of the drone D3 calculates a drone coordinate of the drone D3 according to the satellite signal, and the distributed control circuit 11 of the drone D3 determines a relative distance between the drone D3 and the third interference source J3 according to the interference signal strength of the third interference signal. When the positioning antenna module 14 of the drone D3 receives the third interference signal, a relative orientation between the drone D3 and the third interference source J3 can be obtained by the positioning antenna module 14 of the drone D3. The distributed control circuit 11 of the drone D3 calculates a current interference source coordinate of the third interference source J3 according to the relative distance, the relative orientation and the drone coordinate of the drone D3.

The positioning antenna module 14 of the drone D3 transmits the current interference source coordinate of the third interference source J3 to the remote-control device 2 corresponding to the drone D3, and the remote-control antenna module 23 of the remote-control device 2 receives the current interference source coordinate of the third interference source J3 and transmits the current interference source coordinate of the third interference source J3 to the processing circuit 21 of the remote-control device 2. The processing circuit 21 of the remote-control device 2 reads the current interference source coordinates of the third interference source J3 and stores the current interference source coordinates of the third interference source J3 in the storage circuit 22 of the remote-control device 2. The processing circuit 21 of the remote-control device 2 transmits the current interference source coordinate of the third interference source J3 to the server device 3 through the remote-control antenna module 23.

The server antenna module 33 receives the current interference source coordinate of the third interference source J3, and transmits the current interference source coordinate of the third interference source J3 to the central control circuit 31. The central control circuit 31 reads the current interference source coordinate of the third interference source J3 and calculates the updated electronic fence information according to the current interference source coordinate of the third interference source J3. The central control circuit 31 replaces the historical electronic fence information stored in the storage circuit 32 with the updated electronic fence information. The central control circuit 31 transmits the updated electronic fence information to the plurality of remote-control devices 2 through the server antenna module 33, and the plurality of remote-control devices 2 transmit the updated electronic fence information to the plurality of positioning devices 1, respectively.

When the positioning device 1 of the drone D1 receives the updated electronic fence information, the motor controller of drone D1 controls the drone D1 to move away from the interference range of the updated electronic fence information in advance. When the positioning device 1 of the drone D2 receives the updated electronic fence information, the motor controller of the drone D2 controls the drone D2 to move away from the interference range of the updated electronic fence information in advance. When the positioning device 1 of the drone D3 receives the updated electronic fence information, the motor controller of the drone D3 controls the drone D3 to move away from the interference range of the updated electronic fence information. When the positioning device 1 of the drone D4 receives the updated electronic fence information, the motor controller of the drone D4 controls the drone D4 to move away from the interference range of the updated electronic fence information in advance.

In this way, as long as one drone is interfered by a new interference source, other drones that have not been interfered by the interference source can move in advance in the direction away from the interference source.

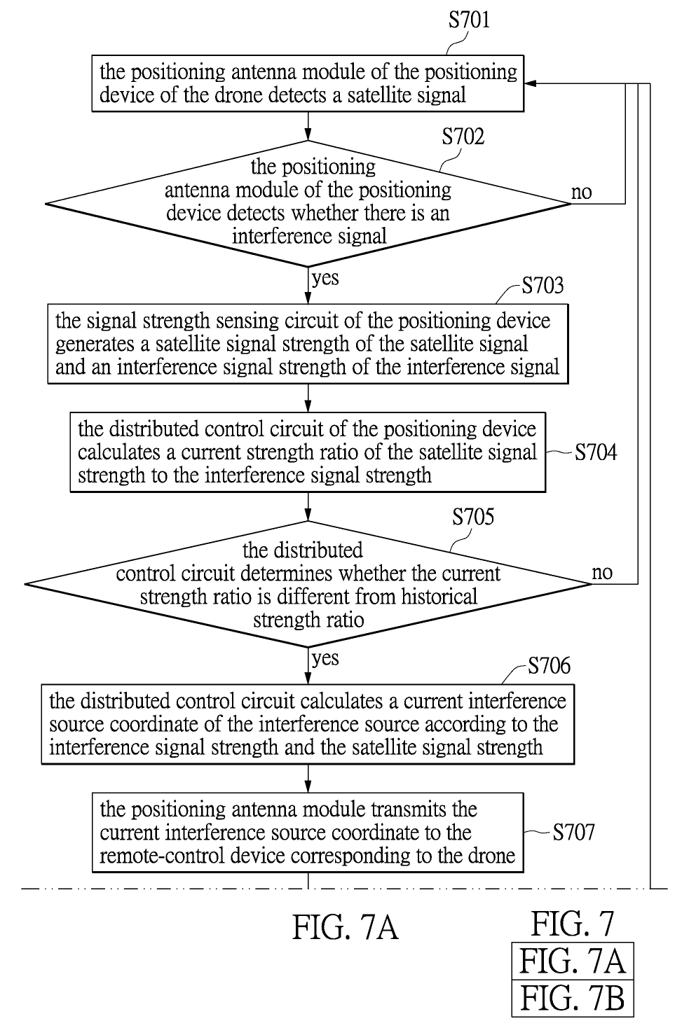

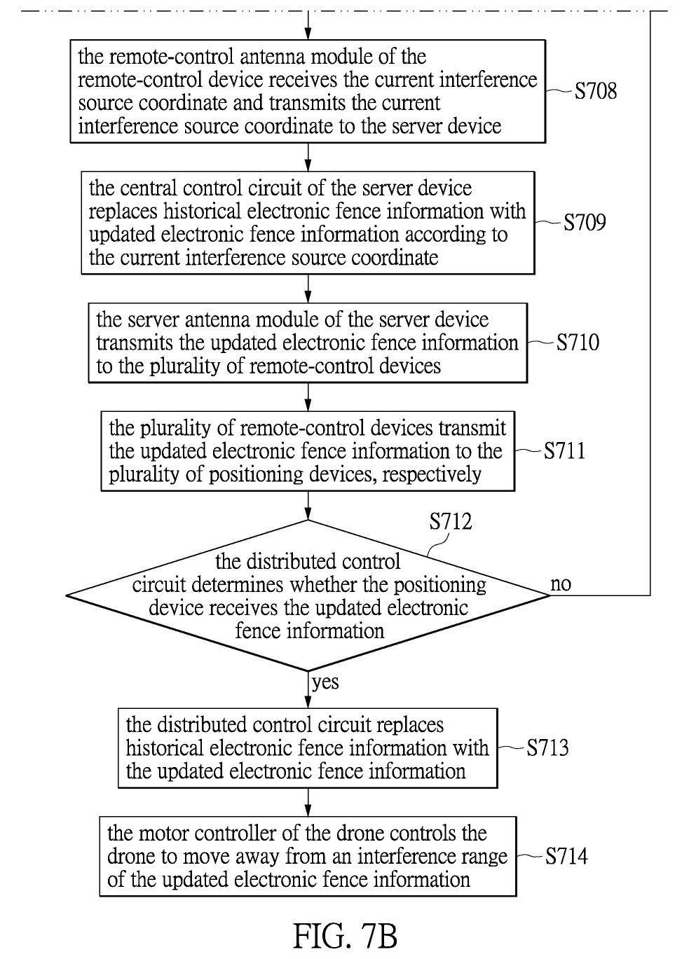

FIGS. 7A-7B shows a flowchart of a flight control method of the drone group according to the first embodiment of the present disclosure. In step S701, the positioning antenna module 14 of the positioning device 1 of the drone detects a satellite signal.

In step S702, the positioning antenna module 14 of the positioning device 1 detects whether there is an interference signal.

When the positioning antenna module 14 detects that there is the interference signal, the method proceeds to step S703. When the positioning antenna module 14 does not detect the interference signal, the method returns to step S701. Specifically, a frequency band of the interference signal is approximately 1.575 GHZ to 1.605 GHZ.

In step S703, the signal strength sensing circuit 13 of the positioning device 1 generates a satellite signal strength of the satellite signal and an interference signal strength of the interference signal.

In step S704, the distributed control circuit 11 of the positioning device 1 calculates a current strength ratio of the satellite signal strength to the interference signal strength.

Regarding step S705, the distributed control circuit 11 determines whether the current strength ratio is different from historical strength ratio. When the current strength ratio is different from the historical strength ratio, the method proceeds to step S706. When the current strength ratio is the same as the historical strength ratio, the method returns to step S701.

Regarding step S706, the distributed control circuit 11 calculates a current interference source coordinate of the interference source according to the interference signal strength and the satellite signal strength.

In step S707, the positioning antenna module 14 transmits the current interference source coordinate to the remote-control device 2 corresponding to the drone. Specifically, the communication frequency band between the drone and the remote-control device 2 is approximately 2.4GHZ~5GHZ.

In step S708, the remote-control antenna module 23 of the remote-control device 2 receives the current interference source coordinate and transmits the current interference source coordinate to the server device 3.

In step S709, the central control circuit 31 of the server device 3 replaces historical electronic fence information with updated electronic fence information according to the current interference source coordinate. The historical electronic fence information is stored in the storage circuit 32 of the server device 3.

In step S710, the server antenna module 33 of the server device 3 transmits the updated electronic fence information to the plurality of remote-control devices 2.

In step S711, the plurality of remote-control devices 2 transmit the updated electronic fence information to the plurality of positioning devices 1, respectively.

In step S712, the distributed control circuit 11 determines whether the positioning device 1 receives the updated electronic fence information.

When the positioning device 1 receives the updated electronic fence information, the method proceeds to step S713. When the positioning device 1 does not receive the updated electronic fence information, the method returns to step S701.

In step S713, the distributed control circuit 11 replaces historical electronic fence information with the updated electronic fence information. The historical electronic fence information is stored in the storage circuit 12 of the positioning device 1.

In step S714, the motor controller M of the drone controls the drone to move away from an interference range of the updated electronic fence information.

Thus, when one of the drones detects a new interference source, the other drones can move in advance in a direction away from the new interference source.

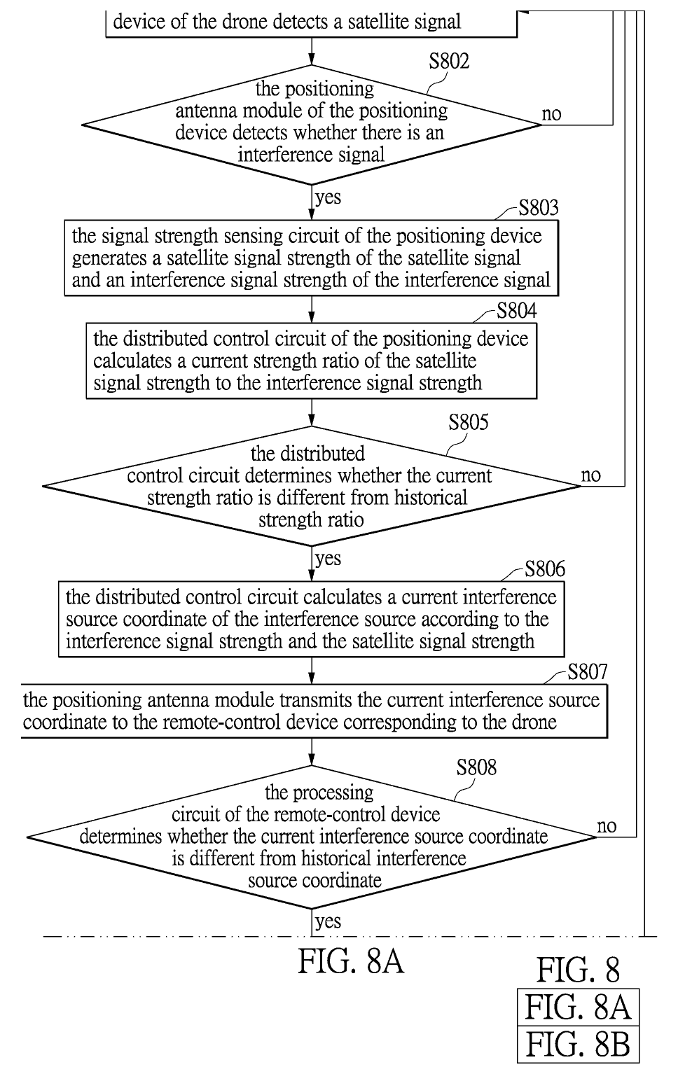

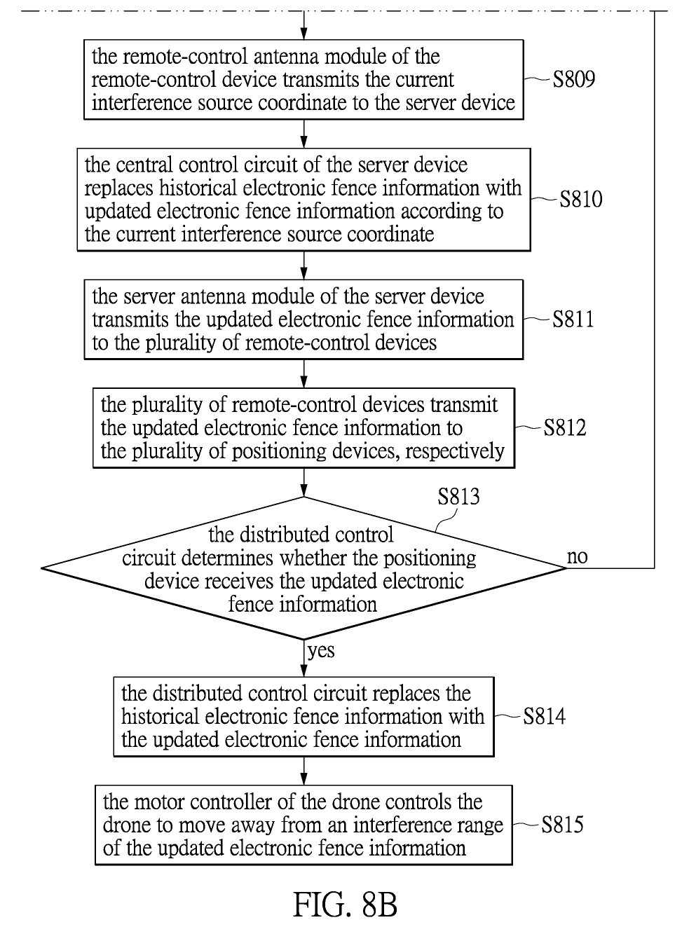

FIGS. 8A-8B shows a flowchart of the flight control method of the drone group according to a second embodiment of the present disclosure.

In step S801, the positioning antenna module 14 of the positioning device 1 of the drone detects a satellite signal.

In step S802, the positioning antenna module 14 of the positioning device 1 detects whether there is an interference signal.

When the positioning antenna module 14 detects that there is the interference signal, the method proceeds to step S803. When the positioning antenna module 14 does not detect the interference signal, the method returns to step S801.

In step S803, the signal strength sensing circuit 13 of the positioning device 1 generates a satellite signal strength of the satellite signal and an interference signal strength of the interference signal.

In step S804, the distributed control circuit 11 of the positioning device 1 calculates a current strength ratio of the satellite signal strength to the interference signal strength.

Regarding step S805, the distributed control circuit 11 determines whether the current strength ratio is different from the historical strength ratio.

When the current strength ratio is different from the historical strength ratio, the method proceeds to step S806. When the current strength ratio is the same as the historical strength ratio, the method returns to step S801.

Regarding step S806, the distributed control circuit 11 calculates a current interference source coordinate of the interference source according to the interference signal strength and the satellite signal strength.

In step S807, the positioning antenna module 14 transmits the current interference source coordinate to the remote-control device 2 corresponding to the drone.

Regarding step S808, the processing circuit 21 of the remote-control device 2 determines whether the current interference source coordinate is different from the historical interference source coordinate. Specifically, the historical interference source coordinate is stored in the storage circuit 22 of the remote-control device 2, and the historical interference source coordinate is an interference source coordinate received previously by the remote-control device 2 from the positioning device 1.

When the current interference source coordinate is different from the historical interference source coordinate, the method proceeds to step S809. When the current interference source coordinate is the same as the historical interference source coordinate, the method returns to step S801.

In step S809, the remote-control antenna module 23 of the remote-control device 2 transmits the current interference source coordinate to the server device 3.

In step S809, the remote-control antenna module 23 of the remote-control device 2 transmits the current interference source coordinate to the server device 3.

In step S810, the central control circuit 31 of the server device 3 replaces historical electronic fence information with updated electronic fence information according to the current interference source coordinate.

In step S811, the server antenna module 33 of the server device 3 transmits the updated electronic fence information to the plurality of remote-control devices 2.

In step S812, the plurality of remote-control devices 2 transmit the updated electronic fence information to the plurality of positioning devices 1, respectively.

In step S813, the distributed control circuit 11 determines whether the positioning device 1 receives the updated electronic fence information.

When the positioning device 1 receives the updated electronic fence information, the method proceeds to step S814. When the positioning device 1 does not receive the updated electronic fence information, the method returns to step S801.

In step S814, the distributed control circuit 11 replaces the historical electronic fence information with the updated electronic fence information.

In step S815, the motor controller M of the drone controls the drone to move away from an interference range of the updated electronic fence information.

When one of the drones detects an interference signal, the remote-control device reconfirms whether the interference signal comes from a new interference source, and the other drones can move in a direction away from the new interference source in advance.

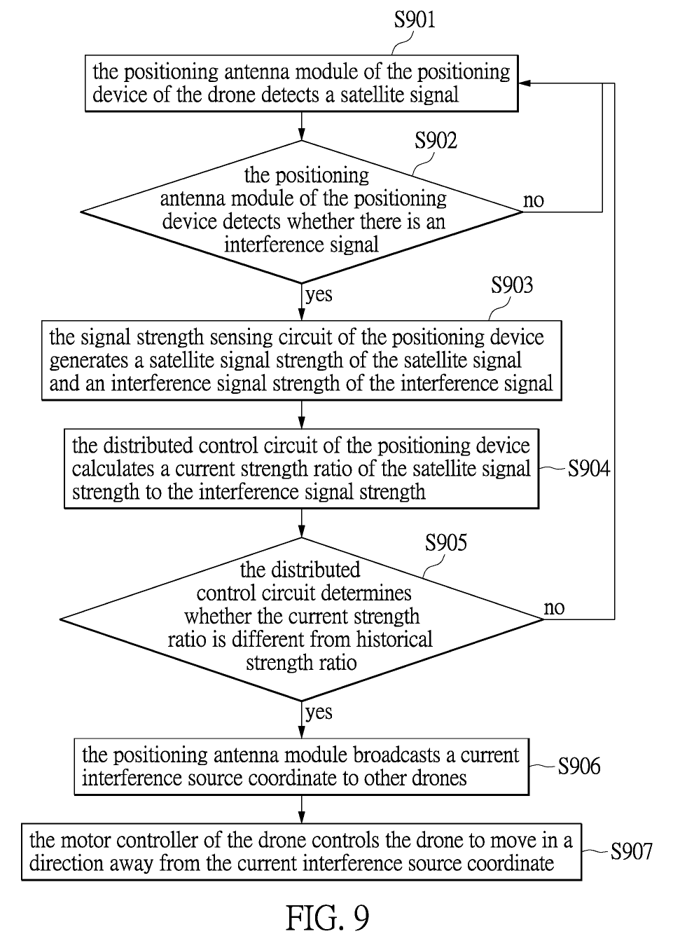

FIG. 9 is a flowchart of the flight control method of the drone group according to a third embodiment of the present disclosure.

In step S901, the positioning antenna module 14 of the positioning device 1 of the drone detects a satellite signal.

In step S902, the positioning antenna module 14 of the positioning device 1 detects whether there is an interference signal.

When the positioning antenna module 14 detects that there is the interference signal, the method proceeds to step S903. When the positioning antenna module 14 does not detect the interference signal, the method returns to step S901.

In step S903, the signal strength sensing circuit 13 of the positioning device 1 generates a satellite signal strength of the satellite signal and an interference signal strength of the interference signal.

In step S904, the distributed control circuit 11 of the positioning device 1 calculates a current strength ratio of the satellite signal strength to the interference signal strength.

Regarding step S905, the distributed control circuit 11 determines whether the current strength ratio is different from the historical strength ratio.

When the current strength ratio is different from the historical strength ratio, the method proceeds to step S906. When the current strength ratio is the same as the historical strength ratio, the method returns to step S901.

Regarding step S906, the positioning antenna module 14 broadcasts a current interference source coordinate to other drones.

Regarding step S907, the motor controller M of the drone controls the drone to move in a direction away from the current interference source coordinate.

When a drone detects a new interference source, it can immediately broadcast a coordinate of the new interference source, and drones within a broadcast range can move in advance in a direction away from the new interference source.

### Beneficial Effects of the Embodiments

In conclusion, the flight control system and the flight control method of the drone group provided by the present disclosure, when the positioning device of any one of drones in the drone group detects that the ratio of the satellite signal strength to the interference signal strength is changed, it indicates that a new interference source has appeared, and the drone interfered by the new interference source transmits the coordinate of the new interference source to the server device through the remote-control device. The server device updates the electronic fence information according to the coordinate of the new interference source, and transmits the updated electronic fence information to each of the drones, so that one part of the drone group that has not been interfered by the new interference source can move away from the interference source in advance, and another part of the drone group that has been interfered by the new interference source immediately moves away from the new interference source.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A flight control system of a drone group, the drone group including a plurality of drones, and the flight control system comprising:
a plurality of positioning devices respectively arranged on the plurality of drones;
a plurality of remote-control devices respectively communicated with the plurality of positioning devices;
a server device communicated with the plurality of the remote-control devices and storing historical electronic fence information;
wherein each of the positioning devices is configured to detect a satellite signal and detect whether there is an interference signal; and
wherein, when the positioning device detects that there is the interference signal, the positioning device is configured to generate a satellite signal strength of the satellite signal and an interference signal strength of the interference signal, and the positioning device is configured to calculate a current strength ratio of the satellite signal strength to the interference signal strength and determine whether the current strength ratio is different from a historical strength ratio;
wherein, when the current strength ratio is different from the historical strength ratio, the positioning device is configured to calculate a current interference source coordinate according to the interference signal strength and the satellite signal strength, and transmit the current interference source coordinate to the server device through the remote-control device;
wherein the server device is configured to replace the historical electronic fence information with updated electronic fence information according to the current interference source coordinate and transmit the updated electronic fence information to the plurality of positioning devices through the plurality of remote-control devices.

2. The flight control system of the drone group according to claim 1, wherein the positioning device includes a signal strength sensing circuit and a positioning antenna module, the positioning antenna module is configured to receive the interference signal and the satellite signal, and the signal strength sensing circuit is configured to sense the satellite signal and the interference signal to generate the satellite signal strength and the interference signal strength.

3. The flight control system of the drone group according to claim 2, wherein the positioning device further includes a distributed control circuit, the distributed control circuit is configured to calculate a drone coordinate based on the satellite signal strength, the distributed control circuit is configured to determine a relative distance and a relative orientation between the drone and an interference source based on the interference signal strength, and the distributed control circuit is configured to calculate the current interference source coordinate based on the relative distance, the relative orientation and the drone coordinate.

4. The flight control system of the drone group according to claim 3, wherein the positioning device includes a storage circuit, and the storage circuit is configured to store the historical strength ratio.

5. The flight control system of the drone group according to claim 1, wherein the remote-control device includes a remote-control antenna module, and the remote-control antenna module is configured to receive the current interference source coordinate and transmit the current interference source coordinate to the server device.

6. The flight control system of the drone group according to claim 1, wherein the server device includes a central control circuit, a storage circuit and a server antenna module, the server antenna module is configured to receive the current interference source coordinate, the storage circuit stores the historical electronic fence information, when the server device receives the updated electronic fence information, the central control circuit is configured to replace the historical electronic fence information with the updated electronic fence information.

7. The flight control system of the drone group according to claim 1, wherein, when the positioning device determines that the current strength ratio is different from the historical strength ratio, the positioning device is configured to broadcast the current interference source coordinate.

8. The flight control system of the drone group according to claim 1, wherein the updated electronic fence information includes an interference range, when the positioning device receives the updated electronic fence information, a motor controller of the drone controls the drone to move away from the interference range.

9. A flight control method of a drone group, the drone group including a plurality of drones corresponding to a plurality of remote-control devices, a plurality of positioning devices respectively provided on the plurality of drones and respectively communicated with the plurality of remote-control devices, the flight control method comprising:
detecting, by each of the positioning devices, a satellite signal;
detecting, by each of the positioning devices, whether there is an interference signal;
wherein, when the positioning device detects that there is the interference signal, the positioning device generates a satellite signal strength of the satellite signal and an interference signal strength of the interference signal;
calculating, by each of the positioning devices, a current strength ratio of the satellite signal strength to the interference signal strength;
determining, by each of the positioning devices, whether the current strength ratio is different from a historical strength ratio;
wherein, when the current strength ratio is different from the historical strength ratio, the positioning device calculates a current interference source coordinate according to the interference signal strength and the satellite signal strength and transmits the current interference source coordinate to the remote-control device;
transmitting, by the remote-control device, the current interference source coordinate to a server device;
replacing, by the server device, historical electronic fence information with updated electronic fence information according to the current interference source coordinate;
transmitting, by the server device, the updated electronic fence information to the plurality of remote-control devices; and
transmitting, by the plurality of remote-control devices, the updated electronic fence information to the plurality of positioning devices, respectively.

10. The flight control method of the drone group according to claim 9, wherein the positioning device includes a storage circuit, and the storage circuit is configured to store the historical electronic fence information.

11. The flight control method of the drone group according to claim 9, further comprising: calculating, by the positioning device, a drone coordinate based on the satellite signal strength; determining, by the positioning device, a relative distance and a relative orientation between the drone and an interference source based on the interference signal strength; and calculating, by the positioning device, the current interference source coordinate based on the relative distance, the relative orientation and the drone coordinate.

12. The flight control method of the drone group according to claim 11, wherein the positioning device includes a storage circuit, and the storage circuit is configured to store the historical strength ratio.

13. The flight control method of the drone group according to claim 9, further comprising: determining, by the positioning device, whether to receive the updated electronic fence information; replacing, by the positioning device, the historical electronic fence information with the updated electronic fence information when the positioning device receives the updated electronic fence information; and detecting, by the positioning device, whether there is the interference signal again when the positioning device does not receive the updated electronic fence information.

14. The flight control method of the drone group according to claim 9, further comprising: determining, by the remote-control device, whether the current interference source coordinate is different from a historical interference source coordinate when the remote-control device receives the current interference source coordinate; and transmitting, by the remote-control device, the current interference source coordinate to the server device when the current interference source coordinate is different from the historical interference source coordinate.

15. The flight control method of the drone group according to claim 9, wherein, when the positioning device determines that the current strength ratio is different from the historical strength ratio, the positioning device broadcasts the current interference source coordinate.

16. The flight control method of the drone group according to claim 9, wherein the updated electronic fence information includes an interference range, and when the positioning device receives the updated electronic fence information, a motor controller of the drone controls the drone to move away from the interference range.
